(19) United States
(12) Patent Application Publication
(10) Pub. No.: US 2025/0286889 A1
(43) Pub. Date: Sep. 11, 2025

(54) METHODS AND COMPUTING SYSTEMS FOR CONTROLLING ACCESS TO A RESOURCE

(71) Applicant: Adam Networks Inc., London (CA)

(72) Inventors: David Redekop, London (CA); Francois Driessen, Delaware (CA); Tomas Trebicky, London (CA); Roger Peters, Aylmer (CA); Arthur Wiebe, Aylmer (CA)

(21) Appl. No.: 18/595,959

(22) Filed: Mar. 5, 2024

(51) Int. Cl. H04L 9/40

(52) U.S. Cl. CPC H04L 63/10

(57) ABSTRACT

Methods and computing systems for controlling access to a resource are disclosed. A request is received to access a resource associated with a set of resource tags, each being associated with an access label and a corresponding access rule. The access rules include allow and block. For each resource tag, a corresponding access label is retrieved. It is determined if all of the corresponding ones of the set of access labels are the same. Access to the resource is controlled according to one of the set of access rules corresponding to the corresponding one of the set of access labels if all of the corresponding ones of the set of access labels are the same. Access to the resource is controlled based on a conflict resolution rule if all of the corresponding ones of the set of access labels are not the same.

### TECHNICAL FIELD

The present disclosure relates to computer access systems, and, in particular, to methods and computing systems for controlling access to a resource.

### BACKGROUND

Systems and methods for controlling access to resources are known. Resources for which access is to be restricted are added to a blacklist. When access to a resource is requested, it is determined if the resource is on the blacklist. If the resource is on the blacklist, access to the resource is denied. If, instead, the resource does not appear on the blacklist, access to the resource is permitted.

Some automated systems rely on tags as part of the decision factor for determining whether access to an associated resource is permitted or protected. Tags are identifiers used to represent a group of resources that share similar characteristics for the purpose of providing access to the resources in the group. These scenarios can be problematic when there are conflicts between the decisions related to the tags.

### SUMMARY

In accordance with a first aspect of the present disclosure, there is provided a method for controlling access to a resource, comprising: receiving a request, via a computing system, to access a resource, the resource being associated with at least two of a set of resource tags in a database, a corresponding one of a set of access labels being associated with each of the set of resource tags in the database, each of the set of access labels corresponding to one of a set of access rules in the database, the set of access rules including allow and block; retrieving, for each of the at least two of the set of resource tags, a corresponding one of the set of access labels in the database; determining if all of the corresponding ones of the set of access labels are the same; controlling access to the resource according to one of the set of access rules corresponding to the corresponding one of the set of access labels if all of the corresponding ones of the set of access labels are the same; and controlling access to the resource based on a conflict resolution rule if all of the corresponding ones of the set of access labels are not the same.

In some exemplary embodiments of the first aspect, the method further includes retrieving the at least two of the resource tags associated with the resource.

In some exemplary embodiments of the first aspect, the retrieving the at least two of the resource tags includes requesting the at least two of the resource tags via a network interface of the computing system.

In some exemplary embodiments of the first aspect, the retrieving the at least two of the resource tags includes requesting the at least two of the resource tags via a network interface of the computing system.

In some exemplary embodiments of the first aspect, the conflict resolution rule is selected from a group including selection of a most permissive one of the access rules corresponding to the access labels corresponding to the at least two of the set of resource tags associated with the resource, or selection of a most protective one of the access rules corresponding to the access labels corresponding to the at least two of the set of resource tags associated with the resource.

In some exemplary embodiments of the first aspect, the conflict resolution rule is to send the request to a human for determining whether access to the resource is allowed or blocked.

In some exemplary embodiments of the first aspect, the conflict resolution rule is to send the request to a third-party system determining whether access to the resource is allowed or blocked.

In some exemplary embodiments of the first aspect, the third-party system is an artificial intelligence system.

In some exemplary embodiments of the first aspect, the method further includes associating at least one of the at least two tags with the resource using a machine-learning model.

In some exemplary embodiments of the first aspect, the method further includes: retrieving a conflict override for one of the at least two of the set of resource tags; and controlling access to the resource based on the conflict override and the one of the set of access rules corresponding to the corresponding one of the set of access labels.

In a second aspect of the present disclosure, there is provided a computing system for controlling access to a resource, comprising: one or more processors; and a memory storing a database of resource identifiers associated with resources, the resource identifiers being associated with at least two of a set of resource tags in the database, a corresponding one of a set of access labels being associated with each of the set of resource tags in the database, each of the set of access labels corresponding to one of a set of access rules in the database, the set of access rules including allow and block, the memory also storing machine-executable instructions that, when executed by the one or more processors, cause the computing system to: receive a request to access one of the resources; retrieve, for each of the at least two of the set of resource tags, a corresponding one of the set of access labels; determine if all of the corresponding ones of the set of access labels are the same; control access to the resource according to one of the set of access rules corresponding to the corresponding one of the set of access labels if all of the corresponding ones of the set of access labels are the same; and control access to the resource based on a conflict resolution rule if all of the corresponding ones of the set of access labels are not the same.

In some exemplary embodiments of the second aspect, the machine-executable instructions, when executed by the one or more processors, cause the computing system to retrieve the at least two of the resource tags associated with the resource.

In some exemplary embodiments of the second aspect, the machine-executable instructions, when executed by the one or more processors, cause the computing system to request the at least two of the resource tags via a network interface of the computing system.

In some exemplary embodiments of the second aspect, the machine-executable instructions, when executed by the one or more processors, cause the computing system to request the at least two of the resource tags via a network interface of the computing system.

In some exemplary embodiments of the second aspect, the conflict resolution rule is selected from a group including selection of a most permissive one of the access rules corresponding to the access labels corresponding to the at least two of the set of resource tags associated with the resource, or selection of a most protective one of the access rules corresponding to the access labels corresponding to the at least two of the set of resource tags associated with the resource.

In some exemplary embodiments of the second aspect, the conflict resolution rule is to send the request to a human for determining whether access to the resource is allowed or blocked.

In some exemplary embodiments of the second aspect, the conflict resolution rule is to send the request to a third-party system determining whether access to the resource is allowed or blocked.

In some exemplary embodiments of the second aspect, the third-party system is an artificial intelligence system.

In some exemplary embodiments of the second aspect, the machine-executable instructions, when executed by the one or more processors, cause the computing system to associate the at least two tags with the resource using a machine-learning model.

In some exemplary embodiments of the second aspect, the machine-executable instructions, when executed by the one or more processors, cause the computing system to: retrieve a conflict override for one of the at least two of the set of resource tags; and control access to the resource based on the conflict override and the one of the set of access rules corresponding to the corresponding one of the set of access labels.

In some exemplary embodiments of the first aspect or the second aspect, the computing system is a gateway computing system.

Other aspects and features of the present disclosure will become apparent to those of ordinary skill in the art upon review of the following description of specific implementations of the application in conjunction with the accompanying figures.

### BRIEF DESCRIPTION OF THE DRAWINGS

FIG. 1 is a schematic diagram illustrating a computing system such as a gateway computing system for controlling access to a resource in accordance with some exemplary embodiments and an operating environment.

FIG. 2 is a schematic diagram illustrating various physical and logical components of the gateway computing system of FIG. 1.

FIG. 3 shows a webpage for configuring the gateway computing system of FIG. 2.

FIG. 4 illustrates various exemplary tables in accordance with some exemplary embodiments for use by a computing system for controlling access to a resource, such as the gateway computing system of FIG. 2.

FIG. 5 is a flowchart of a general method of controlling access to a resource in accordance with exemplary embodiments using the gateway computing system of FIG. 2.

FIG. 6 illustrates various exemplary tables in accordance with further exemplary embodiments for use by a computing system for controlling access to a resource, such as the gateway computing system of FIG. 2.

FIG. 7 is a schematic diagram illustrating a computing system for controlling access to a resource in accordance with other exemplary embodiments and its operating environment.

FIG. 8 is a schematic diagram illustrating a computing system for controlling access to a resource in accordance with further exemplary embodiments and its operating environment.

FIG. 9 is a schematic diagram illustrating a computing system for controlling access to a resource in accordance with still other exemplary embodiments and its operating environment.

Unless otherwise specifically noted, articles depicted in the drawings are not necessarily drawn to scale.

### DETAILED DESCRIPTION OF EXAMPLE EMBODIMENTS

The present disclosure is made with reference to the accompanying drawings, in which embodiments are shown. However, many different embodiments may be used, and thus the description should not be construed as limited to the embodiments set forth herein. Rather, these embodiments are provided so that this application will be thorough and complete. Wherever possible, the same reference numbers are used in the drawings and the following description to refer to the same elements, and prime notation is used to indicate similar elements, operations, or steps in alternative embodiments. Separate boxes or illustrated separation of functional elements of illustrated systems and devices does not necessarily require physical separation of such functions, as communication between such elements may occur by way of messaging, function calls, shared memory space, and so on, without any such physical separation. As such, functions need not be implemented in physically or logically separated platforms, although such functions are illustrated separately for ease of explanation herein. Different devices may have different designs, such that although some devices implement some functions in fixed function hardware, other devices may implement such functions in a programmable processor with code obtained from a machine-readable medium. Lastly, elements referred to in the singular may be plural and vice versa, except wherein indicated otherwise either explicitly or inherently by context.

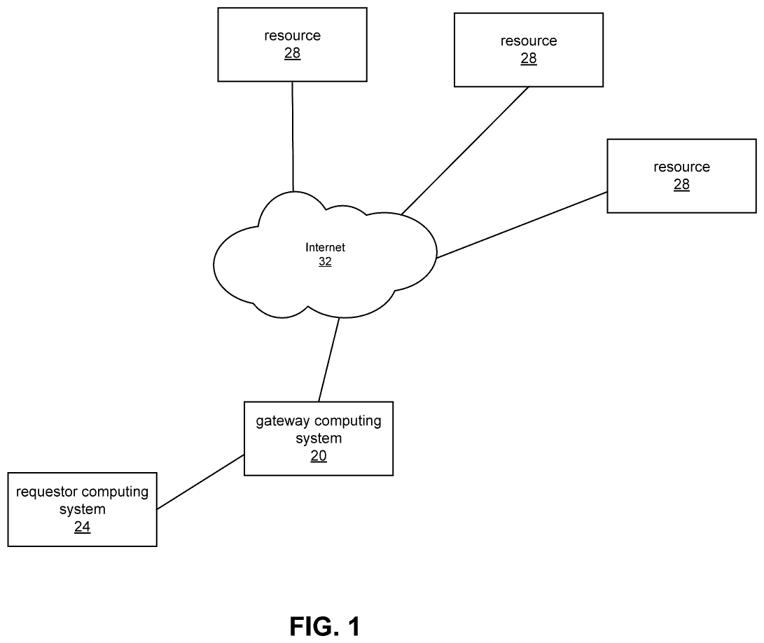

FIG. 1 shows a computing system, such as a gateway computing system 20, for controlling access to a resource in accordance with some exemplary embodiments and an operating environment of the gateway computing system 20.

The resource can be any type of service, content or connection. For example, the resource can be an internet connection, a webpage or a portion thereof, a document, a multimedia file such as a video or a movie, a development asset such as a three-dimensional object model, a database, a library, computer administrative privileges, a service such as an application, network access control etc.

The requestor computing system 24 can be any type of computing device that can make requests for resources. For example, the requestor computing system 24 can be a personal computer, a server computer, a mobile device such as a smartphone or a tablet, a wearable device such as a watch, etc. The requestor computing system 24 is equipped with a network interface for communicating with the gateway computing system 20 wired or wirelessly.

In the illustrated embodiment, the gateway computing system 20 is positioned in a network topology to receive requests from one or more workstation computing systems 24 for resources 28. The gateway computing system 20 acts as a firewall or gateway through which all requests for resources from the requestor computing system 24 are routed. The requests generated by the requestor computing system 24 can be addressed to the gateway computing system 20, invisibly routed through the gateway computing system 20 and intercepted by it, etc.

Resources 28 in FIG. 1 represent computing systems that offer resources. The resource can be any type of service, content or connection. For example, the resource can be an internet connection, a webpage or a portion thereof, a document, a multimedia file such as a video or a movie, a development asset such as a three-dimensional object model, a database, a library, computer administrative privileges, a service such as an application, network access control etc. The resources can be offered by a single computing system, or alternatively, by two or more computing systems.

In response to receiving a request for the requestor computing system 24, the gateway computing system 20 determines if the request should be allowed or blocked based on a set of rules, as will be described below in greater detail. If the request is allowed, the gateway computing system 20 obtains the requested resource 28 from a corresponding computing system by communicating with the corresponding computing system via a private or public data communications network, such as the Internet 32.

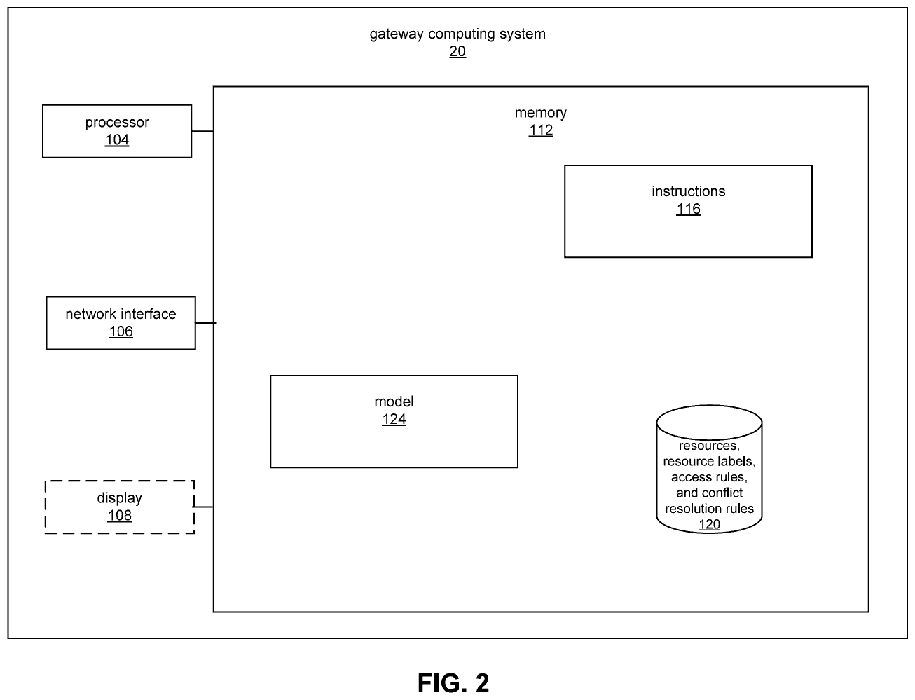

FIG. 2 is a schematic diagram illustrating various physical and logical components of the gateway computing system 20 of FIG. 1, in accordance with exemplary embodiments. Although an example embodiment of the gateway computing system 20 is shown and discussed below, other embodiments may be used to implement examples disclosed herein, which may include components different from those shown. Although FIG. 2 shows a single instance of each component of the gateway computing system 20, there may be multiple instances of each component shown.

The gateway computing system 20 includes one or more processors 104, such as a central processing unit, a microprocessor, an application-specific integrated circuit (ASIC), a field-programmable gate array (FPGA), a dedicated logic circuitry, a tensor processing unit, a neural processing unit, a dedicated artificial intelligence processing unit, or combinations thereof. The one or more processors 104 may collectively be referred to as a processor 104. The gateway computing system 20 may include a display 108 for outputting data and/or information in some applications, but may not in some other applications.

A network interface 106 of the gateway computing system 20 allows the gateway computing system 20 to receive requests for resources, accessing the requested resources, and providing responses to requestors. The network interface 106 can configured for any suitable wired or wireless communications with requestor computer system and computing systems offering the resources.

The gateway computing system 20 includes one or more memories 112 (collectively referred to as “memory 112”), which may include a volatile or non-volatile memory (e.g., a flash memory, a random access memory (RAM), and/or a read-only memory (ROM)). The non-transitory memory 112 may store machine-executable instructions for execution by the processor 104. A set of machine-executable instructions 116 defining a training and application process for controlling access to a resource (described herein) is shown stored in the memory 112, which may be executed by the processor 104 to perform the steps of the methods for training and controlling access to the resource. Further, the memory 112 can store machine-executable instructions for implementing a user interface for configuring the access control for the resources. For example, the user interface can be a web server or a set of interactive web pages, as will be illustrated and described herein. Alternatively, the machine-executable instructions can implement an application for configuring the resource access control. The memory 112 may include other machine-executable instructions for execution by the processor 104, such as machine-executable instructions for implementing an operating system and other applications or functions.

The memory 112 stores a database 120 of a list of resources and/or resource identifiers, zero or more resource tags for each resource, access rules associated with the resource tags, a conflict override for each of a subset of the resource tags, and conflict resolution rules 120 for resolving conflicts between rules for resources. The database can be a set of text files or tables, a relational database, or any other suitable format for storing this data.

A machine-learning model 124 is also stored in the memory 112 of the gateway computing system 20. The machine-learning model 124 is trained using previously tagged resources so that the machine-learning model 124 can predict resource tags for previously untagged resources.

The memory 112 may also store other data, information, rules, policies, and machine-executable instructions described herein.

In some examples, the gateway computing system 20 may also include one or more electronic storage units (not shown), such as a solid state drive, a hard disk drive, a magnetic disk drive and/or an optical disk drive. In some examples, one or more datasets and/or modules may be provided by an external memory (e.g., an external drive in wired or wireless communication with the gateway computing system 20) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The storage units and/or external memory may be used in conjunction with memory 112 to implement data storage, retrieval, and caching functions of the gateway computing system 20.

The components of the gateway computing system 20 may communicate with each other via a bus, for example. In some embodiments, the gateway computing system 20 is a distributed computing system and may include multiple computing devices in communication with each other over a network, as well as optionally one or more additional components. The various operations described herein may be performed by different computing devices of a distributed system in some embodiments. In some embodiments, the gateway computing system 20 is a virtual machine provided by a cloud computing platform.

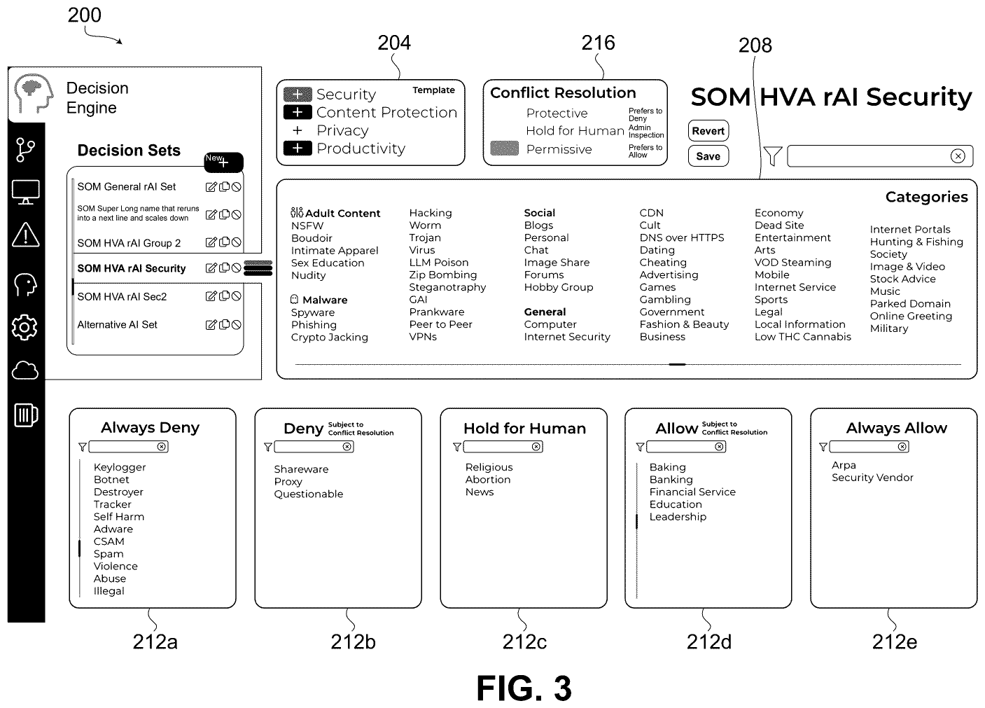

FIG. 3 shows a webpage 200 generated by the gateway computing system 20 of FIG. 2 for configuring the resource access control functionality of the computing system 20. The gateway computing system 20 provides a set of template settings that an administrator can use as a starting point for setting up rules for the resource access control. These are selectable and effectable via a template panel 204. A category panel 208 shows a set of resource tags for default categories for applying to resources. The resource tags include, for example, “NSFW”, “phishing”, “pornography”, “racism”, “sports”, “news”, etc. The tags for the categories from the category panel 208 can be dragged into one of five access lists 212a to 212e. These are an always deny access list 212a, a deny access list 212b, a hold for human access list 212c, an allow access list 212d, and an always allow access list 212e. Resources with resource tags placed in the always deny access list 212a are, by default, always denied access to. Resources with resource tags placed in the deny access list 212b are, by default, denied access to. Resources with resource tags placed in the hold for human access list 212c are, by default, held for a human to review and determine whether the resource can be accessed. Resources with resource tags placed in the allow access list 212d are, by default, allowed access to. Resources with resource tags placed in the always allow access list 212e are, by default, always allowed access to.

In effect, there can be no difference in some cases between the always deny access list 212a and the deny access list 212b. If a first resource has a single resource tag placed in the always deny access list 212a, and a second resource has a single resource tag placed in the deny access list 212b, these two resources are handled in the same manner. The difference between these two lists surfaces when a resource is provided with two or more resource tags that have conflicting actions. For example, a resource can have two tags: one placed in the deny access list 212b, and one placed in the allow access list 212d. As neither access list is deemed to have an innate higher weight, there is an initial conflict. If, instead, a resource has two tags, one placed in the always deny access list 212a, and one placed in the allow access list 212d, it may be the case that access to the resource is denied, as the access rule for resource tags placed in the always deny access list 212a is deemed to override the less weighted access rule for resource tags placed in the allow access list 212d.

Similarly, there can be no difference in some cases between the allow access list 212d and the always allow access list 212d. If a first resource has a single resource tag placed in the allow access list 212d, and a second resource has a single resource tag placed in the always allow access list 212e, these two resources are handled in the same manner. The difference between these two lists surfaces when a resource is provided with two or more resource tags that have conflicting actions. For example, a resource can have two tags: one placed in the deny access list 212b, and one placed in the allow access list 212d. As neither access list is deemed to have an innate higher weight, there is an initial conflict. If, instead, a resource has two tags, one placed in the deny access list 212b, and one placed in the always allow access list 212e, it may be the case that access to the resource is allowed, as the access rule for resource tags placed in the always allow access list 212e is deemed to override the less weighted access rule for resource tags placed in the deny access list 212b.

A conflict resolution panel 216 enables an administrator to select a conflict resolution rule. In the example embodiment illustrated, the conflict resolution rule is used to determine whether access to a resource is allowed or denied when there is a conflict in the access rules associated with the resource tags applied to the resource. In FIG. 3, “permissive” is shown being selected. As a result, resources having resource tags placed in both the deny access list 212b and the allow access list 212d will be permitted to be accessed.

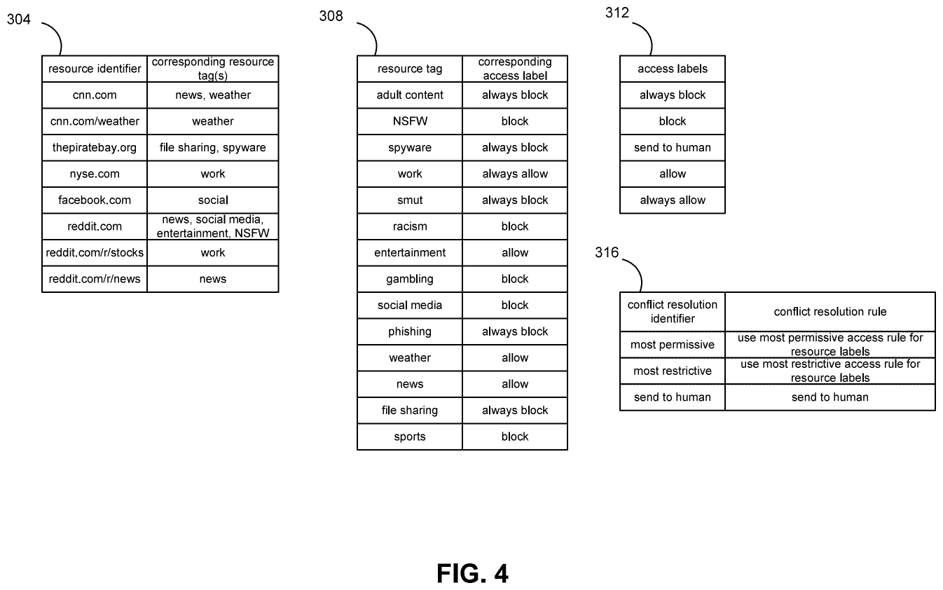

FIG. 4 illustrates various exemplary tables in accordance with some exemplary embodiments for use by the gateway computing system 20 for controlling access to a resource. In particular, there is a resource-to-resource-tag mapping table 304, a resource-tag-to-access-label mapping table 308, an access label table 312, and a conflict resolution rule table 316. The resource-to-resource-tag mapping table 304 registers the mappings between resources and resource tags presenting categories. In this particular example, the resources are web pages in domains. For example, web pages forming part of the cnn.com domain are tagged as “news” and “weather”. However, web pages with universal resource locators (URLs) commencing with cnn.com/weather are tagged as “weather” only. As illustrated, some resources are labeled with a single resource tag. Other resources, however, are tagged with two or more resource tags.

The resource-tag-to-access-label mapping table 308 maps resource tags to an access rule (referenced via its access label from the access label table 312). For example, for a resource with a resource tag of “work”, a corresponding access label of “always allow” is indicated. That is, since it is important to have workers access resources required for work, these resources are tagged with a “work” resource tag that is associated with an “always allow” access label. For a resource that is tagged with a “social media” resource tag, access to the resource is blocked as per the corresponding access label of “block”.

The conflict resolution rule table 316 records a list of the conflict resolution identifiers and, for each, the corresponding conflict resolution rule. As will be appreciated, the conflict resolution rules may be coded in some manner that is machine-readable and can be acted upon.

As will be appreciated, the identifiers and tags in these tables can be coded in some other manner. For example, the access labels can be coded as an integer between 0 and 4 that are then mapped to machine-readable code for instructing how these access labels are effected.

While this information is shown in table format, it will be understood that the tag, label, and rule data can be stored in any other suitable format.

In some scenarios, resource tags can be provided that are not associated with any access labels. In these cases, an access label can be assumed for the so-tagged resources. For example, resources with a resource tag that is unassociated with an access label can be permitted by default or blocked by default based on a setting. In another example, depending on a selected conflict resolution rule for the system or a separate conflict resolution rule, such as “block if no associated access label”. In a further example, where there are other resource tags applied to the resource, and one or more of those resource tags have associated access labels, then it may be the case that the resource tag with no associated access label is ignored.

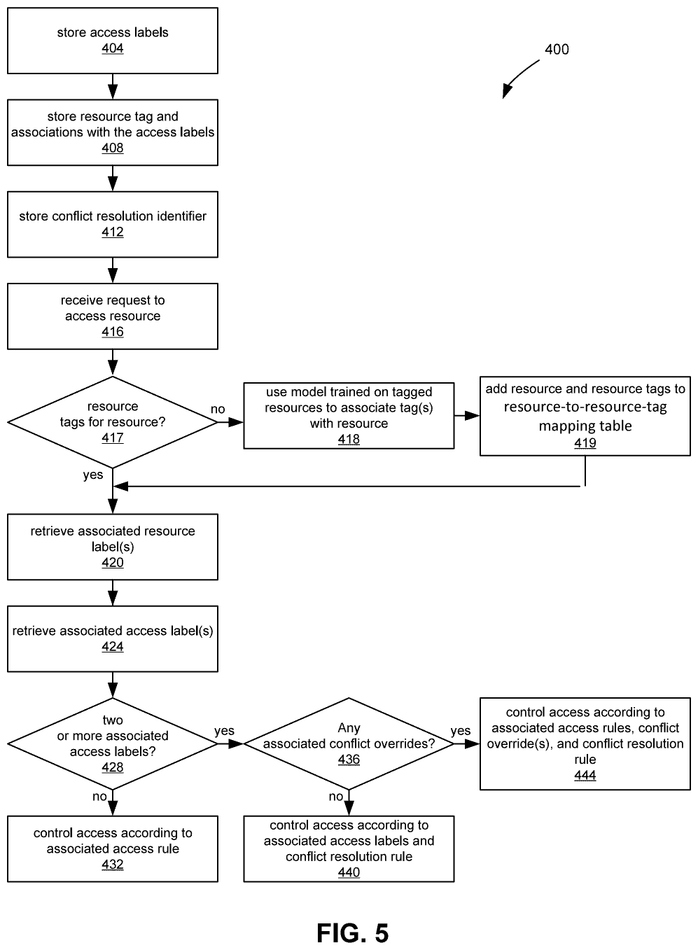

FIG. 5 is a flowchart of a method 400 of controlling access to a resource in accordance with exemplary embodiments using the gateway computing system 20 of FIG. 2. The method 400 begins with the storage of access labels (404). The access labels are stored in the access label table 312, as illustrated in FIG. 4. Next, resource tags and, for each, associations with access labels are stored (408). This is shown in the resource-tag-to-access-label mapping table 308 of FIG. 4 and is a result of the resource tags being dragged into one of the lists 212a to 212e. A conflict resolution identifier is then stored (412). The conflict resolution identifier stored corresponds to a conflict resolution identifier from the conflict resolution rule table 316 from which a rule is picked, such as via the webpage 200 of FIG. 3.

A request to access a resource is then received (416). As previously noted, the request to access the resource can be made either directly or indirectly to the gateway computing system 20 by the requestor computing system 24. A direct request is when the request is addressed to the gateway computing system 20. An indirect request is when the request is addressed to the computing system offering the resource and is intercepted by the gateway computing system 20. The request identifies the resource. For example, in the case of a webpage, the resource request can specify the URL for the webpage. Upon receipt of the resource request, it is determined if there are resource tags for the resource (417). This is determined by determining if the resource is registered in the resource-to-resource-tag mapping table 304. If the resource is not registered in the resource-to-resource-tag mapping table 304, a machine-learning model trained on tagged resources is used to associate tags with the unregistered resource (418). The machine-learning model uses the knowledge from the training set to categorize the unregistered resource to identify one or more resource tags that can be applied.

Alternative to 418, in other exemplary embodiments, if it is determined that there are no resource tags for the requested resource, gateway computing system 20 can be configured to send the resource request to a human to determine whether access to the resource is allowed or blocked.

Once one or more resource tags are determined for the previously unregistered resource, the resource and the resource tags are added to the resource-to-resource-tag mapping table 304 (419).

Next, the associated resource tag or tags is/are retrieved (420). The gateway computing system 20 compares the URL for the resource against the resource identifiers in the resource-to-resource-tag mapping table 304 to locate the corresponding resource tag(s). E.g., if a webpage with a URL of “https://www.reddit.com” is the resource requested, the gateway computing system 20 determines that the resource is associated with the resource tags “news”, “social media”, “entertainment”, and “NSFW”. Next, for each resource tag associated with the resource, the corresponding access label is retrieved (424). The gateway computing system 20 looks up the corresponding access label for each resource tag retrieved at 420 in the resource-tag-to-access-label mapping table 308. For example, for the webpage specified by the URL https://www.reddit.com having the associated resource tags of “news”, “social media”, “entertainment”, and “NSFW”, the corresponding access labels are “allow”, “block”, “allow”, and “block”.

It is then determined if there are two or more associated access labels for the resource (428). If there is only one access label for the resource, the gateway computing device 20 controls access according to the associated access rule (432). If there are two or more access labels, it is determined if there are any associated conflict overrides (436). Conflict overrides include the access labels “always block” and “always allow”. If it is determined that there are no conflict overrides at 436, access to the resource is controlled according to the access rules corresponding to the associated access labels and the conflict resolution rule (440). For example, where a resource has two resource tags and one is associated with an access label of “block” and another is associated with an access label of “allow”, the conflict resolution rule is used to select an appropriate action. The action can include, for example, to select the most permissive or the most protective of the associated access labels, or to send the resource identifier to a human or other automated system for determining whether access should be allowed or blocked. Where the resource identifier is assigned to a human for review, the human reviewer can be provided with an interface for viewing the resource or an analysis/summary thereof, and for making a selection of whether to allow or block access to the resource. In another example, where the resource identifier is passed to a third-party system, such as an artificial intelligence (Al) system. The third-party system can analyze the resource and make a determination as to whether to allow or block access to the resource. Where the third-party system is an Al system, the Al system can be pretrained using a set of allowed or blocked resources.

If, instead, there are one or more associated conflict overrides for the resource, the gateway computing system 20 controls access to the resource according to the associated access rules, the conflict override(s), and the conflict resolution rule (444). For example, where a resource has two resource tags, one being associated with an access label of “allow”, and another being associated with an access label of “always block” (that is, specifying both an access rule and a conflict override), and there is a specified conflict resolution rule of “most permissive”, then access to the resource may be allowed.

In other embodiments, conflict resolution rule(s) can be defined to allow a decision to block or allow using the conflict overrides, where possible, and a most permissive or most protective approach otherwise. In the previously mentioned example where a resource has two resource tags, one being associated with an access label of “allow”, and another being associated with an access label of “always block” (that is, specifying both an access rule and a conflict override), and there is a specified conflict resolution rule of “use the conflict overrides, otherwise most permissive”, then access to the resource may be blocked, since the conflict override for the second label supercedes the access rule for the first label.

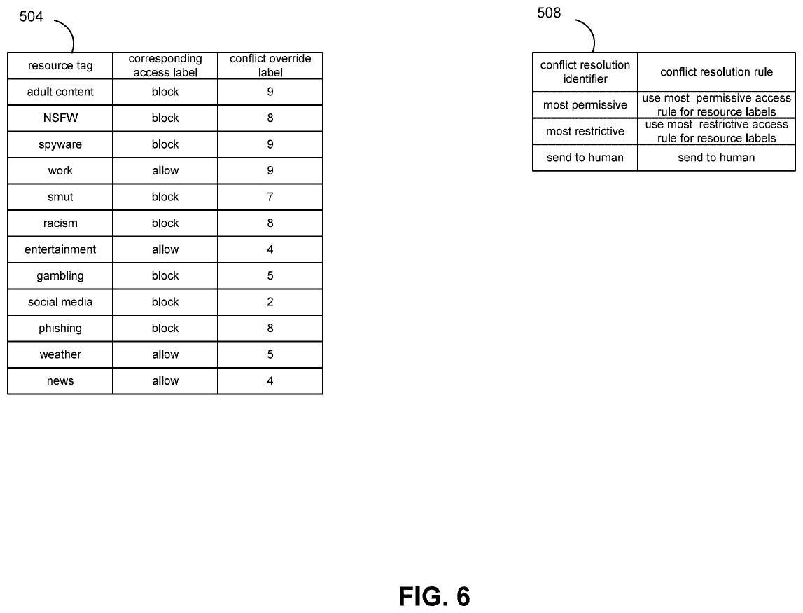

FIG. 6 illustrates various exemplary tables in accordance with further exemplary embodiments for use by the computing system 20 of FIG. 2 for controlling access to a resource. In this alternative schema, each resource tag is associated with an access label and a conflict override label in a resource-tag-to-access-label mapping table 504. The conflict override label is a number selected in a range; in this case, the range is 1 to 9 and the numbers are integers. The access label and the conflict override label corresponding to each of the resource tags for a resource are compared. If, for example, a resource has two tags that are associated with, respectively, a first access label “block” and a second access label “allow”, and the corresponding conflict override tags are 7 and 9, then the gateway computing system 20 may allow the access as the resource as the conflict override label corresponding to the access label “allow” is greater than the conflict override label corresponding to the access label “block”.

A conflict resolution rule table 508 records a list of the conflict resolution identifiers and, for each, the corresponding conflict resolution rule. As will be appreciated, the conflict resolution rules may be coded in some manner that is machine-readable and can be acted upon.

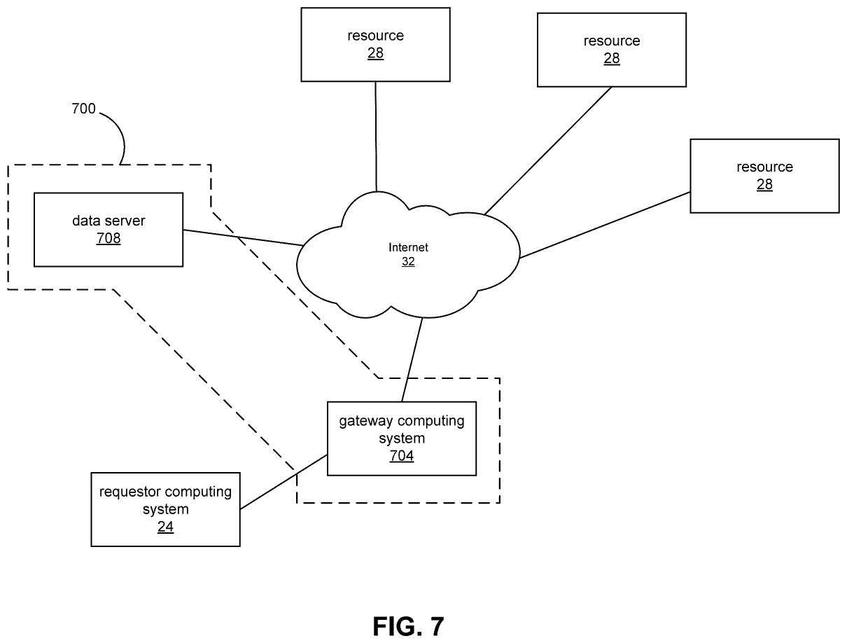

FIG. 7 is a schematic diagram illustrating a gateway computing system 704 for controlling access to a resource in accordance with other exemplary embodiments and an operating environment of the gateway computing system 704. In this example embodiment, the functionality provided by the gateway computing system 20 of FIG. 1 is provided by the gateway computing system 704 and a remote data server 708 (also denoted data server 708) acting together as a distributed computer system 700. In particular, in this exemplary embodiment, the data server 708 stores the resources, resource tags, access rules, and conflict resolution rules, and the gateway computing system 704 retrieves this data as needed. By shifting this data to the data server 708 remote to the gateway computing system 704, the data managed by the data server 708 can be used to enable more than one gateway computing system 704 to use the same information to control access to resources for users in different locations. As a result, the computing system 700 controlling access to resources refers to a combination of the gateway computing system 704 and the data server 708.

In alternative embodiments, the gateway computing system 704 for controlling access to resources can be remote to the requestor computing system 24.

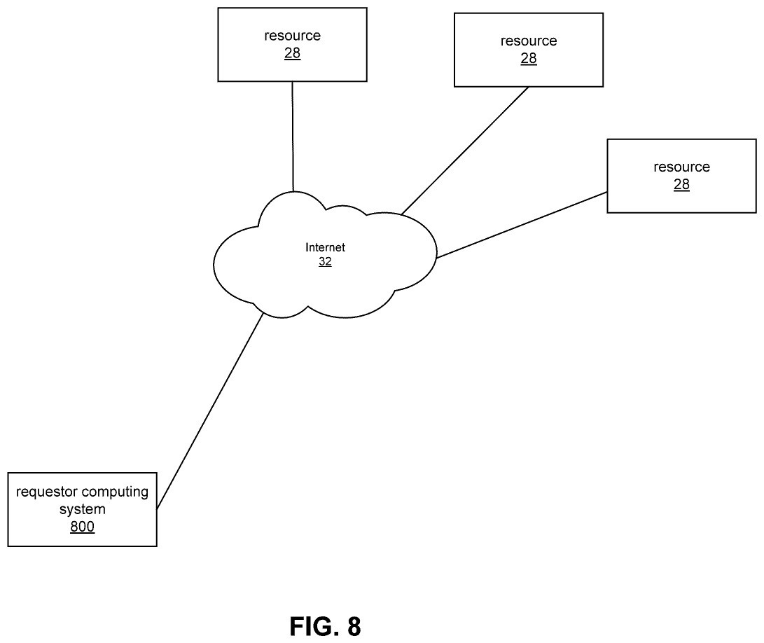

FIG. 8 is a schematic diagram illustrating a requestor computing system 800 for controlling access to a resource in accordance with further exemplary embodiments and an operating environment of the requestor computing system 800. In the illustrated example, a requestor computing system 800 includes the functionality of the gateway computing system 20 of FIG. 2. As a result, requests can either be directed to the access control functionality or can be intercepted by the access control functionality.

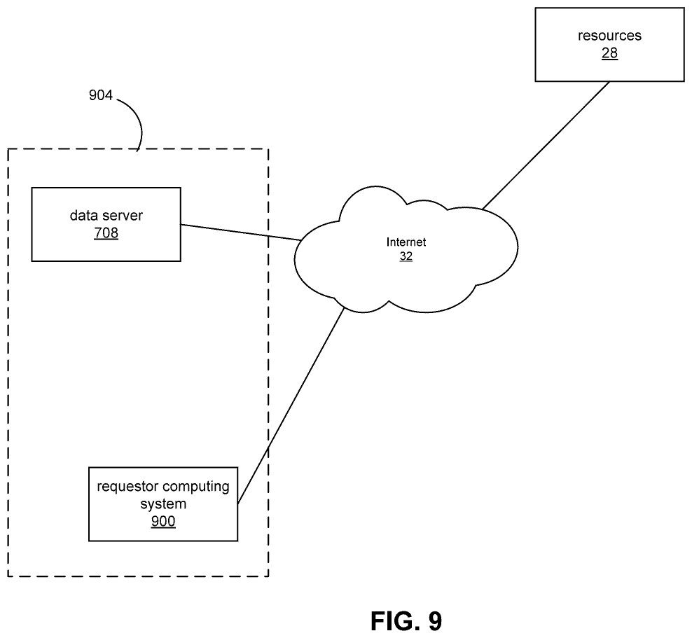

FIG. 9 is a schematic diagram illustrating a computing system 904 including a requestor computing system 900 for controlling access to a resource in accordance with still other exemplary embodiments and an operating environment of the computing system 904. This configuration is a variant of the configuration shown in FIG. 8, in which the data server 708 stores the resources, resource tags, access rules, and conflict resolution rules, and the requestor computing system 900 retrieves this data as needed. The requestor computing system 900 includes the access control functionality provided by the gateway computing system in the scenario shown in FIG. 1. By shifting this data to the data server 708 remote to the gateway computing system 900, the data managed by the data server 708 can be used to enable more than one requestor computing system 900 to control access to the resources for users in different locations. As a result, a computing system 904 controlling access to resources refers to a combination of the requestor computing system 900 and the data server 708.

Further, as shown in FIG. 9, the resources 28 for which access is controlled by the requestor computing system 900 and the data server 708 can be offered by a single computing system.

The steps (also referred to as operations) in the flowcharts and drawings described herein are for purposes of example only. There may be many variations to these steps/operations without departing from the teachings of the present disclosure. For instance, the steps may be performed in a differing order, or steps may be added, deleted, or modified, as appropriate.

In other embodiments, the same approaches and examples described herein can be employed for other modalities.

Through the descriptions of the preceding embodiments, the present invention may be implemented by using hardware only, or by using software and a necessary universal hardware platform, or by a combination of hardware and software. The coding of software for carrying out the above-described methods described is within the scope of a person of ordinary skill in the art having regard to the present disclosure.

Based on such understandings, the technical solution of the present invention may be embodied in the form of a software product. The software product may be stored in a non-volatile or non-transitory storage medium, which can be an optical storage medium, flash drive or hard disk. The software product includes a number of instructions that enable a computing device (e.g., the gateway computing device 20, personal computer, server, or network device) to execute the methods provided in the embodiments of the present disclosure.

All values and sub-ranges within disclosed ranges are also disclosed. Also, although the systems, devices and processes disclosed and shown herein may comprise a specific plurality of elements, the systems, devices, and assemblies may be modified to comprise additional or fewer of such elements. Although several example embodiments are described herein, modifications, adaptations, and other implementations are possible. For example, substitutions, additions, or modifications may be made to the elements illustrated in the drawings, and the example methods described herein may be modified by substituting, reordering, or adding steps to the disclosed methods.

Features from one or more of the above-described embodiments may be selected to create alternate embodiments comprised of a sub-combination of features which may not be explicitly described above. In addition, features from one or more of the above-described embodiments may be selected and combined to create alternate embodiments comprised of a combination of features which may not be explicitly described above. Features suitable for such combinations and sub-combinations would be readily apparent to persons skilled in the art upon review of the present disclosure as a whole.

In addition, numerous specific details are set forth to provide a thorough understanding of the example embodiments described herein. It will, however, be understood by those of ordinary skill in the art that the example embodiments described herein may be practiced without these specific details. Furthermore, well-known methods, procedures, and elements have not been described in detail so as not to obscure the example embodiments described herein. The subject matter described herein and in the recited claims intends to cover and embrace all suitable changes in technology.

Although the present invention and its advantages have been described in detail, it should be understood that various changes, substitutions, and alterations can be made herein without departing from the invention as defined by the appended claims.

The present invention may be embodied in other specific forms without departing from the subject matter of the claims. The described example embodiments are to be considered in all respects as being only illustrative and not restrictive. The present disclosure intends to cover and embrace all suitable changes in technology.

The scope of the present disclosure is, therefore, described by the appended claims rather than by the foregoing description. The scope of the claims should not be limited by the embodiments set forth in the examples, but should be given the broadest interpretation consistent with the description as a whole.

1. A method for controlling access to a resource, comprising:
receiving a request, via a computing system, to access a resource, the resource being associated with at least two of a set of resource tags in a database, a corresponding one of a set of access labels being associated with each of the set of resource tags in the database, each of the set of access labels corresponding to one of a set of access rules in the database, the set of access rules including allow and block;
retrieving, for each of the at least two of the set of resource tags, a corresponding one of the set of access labels in the database;
determining if all of the corresponding ones of the set of access labels are the same;
controlling access to the resource according to one of the set of access rules corresponding to the corresponding one of the set of access labels if all of the corresponding ones of the set of access labels are the same; and
controlling access to the resource based on a conflict resolution rule if all of the corresponding ones of the set of access labels are not the same.

2. The method of claim 1, further comprising:
retrieving the at least two of the resource tags associated with the resource.

3. The method of claim 2, wherein the retrieving the at least two of the resource tags includes requesting the at least two of the resource tags via a network interface of the computing system.

4. The method of claim 2, wherein the retrieving the at least two of the resource tags includes requesting the at least two of the resource tags via a network interface of the computing system.

5. The method of claim 1, wherein the conflict resolution rule is selected from a group including selection of a most permissive one of the access rules corresponding to the access labels corresponding to the at least two of the set of resource tags associated with the resource, or selection of a most protective one of the access rules corresponding to the access labels corresponding to the at least two of the set of resource tags associated with the resource.

6. The method of claim 1, wherein the conflict resolution rule is to send the request to a human for determining whether access to the resource is allowed or blocked.

7. The method of claim 1, wherein the conflict resolution rule is to send the request to a third-party system determining whether access to the resource is allowed or blocked.

8. The method of claim 7, wherein the third-party system is an artificial intelligence system.

9. The method of claim 1, further comprising:
associating at least one of the at least two tags with the resource using a machine-learning model.

10. The method of claim 1, further comprising:
retrieving a conflict override for one of the at least two of the set of resource tags; and
controlling access to the resource based on the conflict override and the one of the set of access rules corresponding to the corresponding one of the set of access labels.

11. A computing system for controlling access to a resource, comprising:
one or more processors; and
a memory storing a database of resource identifiers associated with resources, the resource identifiers being associated with at least two of a set of resource tags in the database, a corresponding one of a set of access labels being associated with each of the set of resource tags in the database, each of the set of access labels corresponding to one of a set of access rules in the database, the set of access rules including allow and block, the memory also storing machine-executable instructions that, when executed by the one or more processors, cause the computing system to:
receive a request to access one of the resources;
retrieve, for each of the at least two of the set of resource tags, a corresponding one of the set of access labels;
determine if all of the corresponding ones of the set of access labels are the same;
control access to the resource according to one of the set of access rules corresponding to the corresponding one of the set of access labels if all of the corresponding ones of the set of access labels are the same; and
control access to the resource based on a conflict resolution rule if all of the corresponding ones of the set of access labels are not the same.

12. The computing system of claim 11, wherein the machine-executable instructions, when executed by the one or more processors, cause the computing system to retrieve the at least two of the resource tags associated with the resource.

13. The computing system of claim 11, wherein the machine-executable instructions, when executed by the one or more processors, cause the computing system to request the at least two of the resource tags via a network interface of the computing system.

14. The computing system of claim 12, wherein the machine-executable instructions, when executed by the one or more processors, cause the computing system to request the at least two of the resource tags via a network interface of the computing system.

15. The computing system of claim 11, wherein the conflict resolution rule is selected from a group including selection of a most permissive one of the access rules corresponding to the access labels corresponding to the at least two of the set of resource tags associated with the resource, or selection of a most protective one of the access rules corresponding to the access labels corresponding to the at least two of the set of resource tags associated with the resource.

16. The computing system of claim 11, wherein the conflict resolution rule is to send the request to a human for determining whether access to the resource is allowed or blocked.

17. The computing system of claim 11, wherein the conflict resolution rule is to send the request to a third-party system determining whether access to the resource is allowed or blocked.

18. The computing system of claim 17, wherein the third-party system is an artificial intelligence system.

19. The computing system of claim 10, wherein the machine-executable instructions, when executed by the one or more processors, cause the computing system to associate at least one of the at least two tags with the resource using a machine-learning model.

20. The computing system of claim 11, wherein the machine-executable instructions, when executed by the one or more processors, cause the computing system to:
retrieve a conflict override for one of the at least two of the set of resource tags; and
control access to the resource based on the conflict override and the one of the set of access rules corresponding to the corresponding one of the set of access labels.
